(19) United States
(12) Patent Application Publication
(10) Pub. No.: US 2009/0268475 A1
(43) Pub. Date: Oct. 29, 2009

(54) VENTILATION SYSTEM FOR LAMP ENCLOSURES

(76) Inventors: Earl Ball, Middletown, DE (US); David T. DeGuiseppi, Chadds Ford, PA (US); Robert Lavertu, Perry Hall, MD (US)

Correspondence Address: W. L. Gore & Associates, Inc., 551 Paper Mill Road, P.O. Box 9206, Newark, DE, 19714-9206, US

(21) Appl. No.: 12/109,148

(22) Filed: Apr. 24, 2008

(51) Int. Cl. B60Q 1/00; F21V 29/00; F24F 7/00

(52) U.S. Cl. 362/373; 362/547; 454/238

(57) ABSTRACT

A vent for a lamp enclosure comprises a passageway between the interior and exterior of the enclosure, a non-planar vent element covers the passageway. The vent has improved air flow and offers splash protection against liquids.

### BACKGROUND OF THE INVENTION

Vehicle head lamps, brake lamps, running lamps, turn signal lamps, fog lamps and parking lamps (collectively lamps or vehicle lamps) have one or more bulbs located in an enclosure. Thermal cycling due to bulb operation, changes in the environment and vehicle operation can cause moisture to condense on the interior of the lamp enclosure. Such condensation may mar the appearance of the lamp, inhibit light output or cause damage. Therefore, it is desirable to prevent moisture from reaching the bulbs, lens and reflective surfaces in order to maintain effective operation of the lamp and prevent damage.

Attempts to minimize moisture related problems inside lamp enclosures have involved systems that create air flow within the enclosure and/or air exchange between the interior of the enclosure and the environment. Such ventilation systems typically rely on air convection to reduce condensation effects. Multiple openings positioned to optimize air flow to promote moisture removal may be used. Flexible tubes may be attached to such openings. Although these ventilation systems provide a means of increasing airflow through the enclosure or air exchange with the environment, they fail to prevent foreign materials and liquid water from entering the lamp enclosure.

Air flow and exchange in lamp enclosures may be influenced by external air flow from wind, vehicle motion or from the fan and other moving equipment found, for example, in a vehicle engine compartment. Airflow across an opening may cause a pressure differential at the opening. Unequal external conditions at two openings on the lamp enclosure may produce a measurable pressure differential between the two that will cause convective air flow in the lamp enclosure.

There exists a need for an increased air flow ventilation system in vehicle and other lamp enclosures that offers splash protection against liquid water and protection from foreign materials like fine dust.

### SUMMARY

In one aspect, the invention provides a lamp enclosure comprising a ventilation system which includes a first vent located in a first position on the lamp enclosure, the first vent having a first passageway covered by a first air permeable, splashproof venting element, and a second vent located in a second position on the lamp enclosure, the second vent having a second passageway covered by a second air permeable, splashproof venting element and wherein the first air permeable, splashproof venting element has a non-planar shape such that the surface area of the air permeable, splashproof venting element is greater than the area of the first passageway and wherein a pressure difference measurable at the first position and the second position causes airflow within the lamp enclosure.

In another aspect, the invention provides a lamp enclosure having a ventilation system, including an first aperture in a first position on the lamp enclosure, a vent located over the first aperture, the vent having a passageway, wherein the passageway is covered by an air permeable, splashproof venting element, having a non-planar shape such that the surface area of the air permeable, splashproof venting element is greater than the area of the passageway, and a second aperture located in a second position, wherein a pressure difference measurable at the first position and the second position causes airflow within the lamp enclosure.

In another aspect, the invention provides a lamp enclosure comprising a ventilation system including a first aperture in a first position on the lamp enclosure, a non-planar splashproof venting element covering the first aperture, the splashproof venting element comprising a porous material having air permeability greater than 5 Frazier, second aperture located in a second position, and wherein a pressure difference measurable at the first position and the second position causes airflow within the lamp enclosure.

In yet another aspect, the invention provides a ventilated lamp enclosure, the lamp enclosure including a passageway between the interior of the enclosure and the exterior of the lamp enclosure, and a venting element covering the passageway, the venting element comprising a pleated polymeric membrane laminate comprising expanded PTFE and a support material, the laminate having a water entry pressure of greater than 0.1 psi and an air permeability greater than 5 Frazier.

In a still further aspect, the invention provides a system for venting a lamp enclosure having two or more apertures therein, the system includes a vent body having a passageway therethrough, and a venting element covering said passageway, the venting element comprising a pleated non-planar polymeric membrane laminate comprising expanded PTFE and a support material, the laminate having a water entry pressure of at least 0.1 psi, and wherein the venting element has an air permeability greater than 5 Frazier.

### BRIEF DESCRIPTION OF THE DRAWINGS

FIG. 1 represents a cross-sectional view of a vent according to one embodiment.

FIGS. 2a-2d depict several possible embodiments of non-planar venting elements.

FIG. 3 is a cross-sectional view of a vehicle lamp enclosure showing a vent used in a ventilation system according to an aspect of the invention.

FIG. 4 is a cross-sectional view of a vehicle lamp enclosure incorporating a ventilation system in accordance with another aspect.

FIG. 5 is a perspective view of a vent made in accordance with Example 1.

FIG. 6 is a perspective view of a vent made in accordance with Example 2.

FIG. 7 depicts an exploded view of the components of a vent made in accordance with Example 1.

FIG. 8 depicts an exploded view of the components of a vent made in accordance with Example 2.

FIG. 9 shows a cross-sectional view of a lamp enclosure including two vents in two positions in a ventilation system according to an aspect of the invention.

### DETAILED DESCRIPTION OF THE INVENTION

The ventilation system described herein is useful for moisture control in lamp enclosures. Specifically, the system provides a vent which has a unique combination of high air flow without sacrificing splash protection from water. The ventilation system has application in any lighting enclosure, for example in outdoor lighting and decorative lighting. The system is particularly well suited for automobile, truck, motorcycle and boat lamps as well as other vehicle lamps and lighting applications where condensation may be problematic.

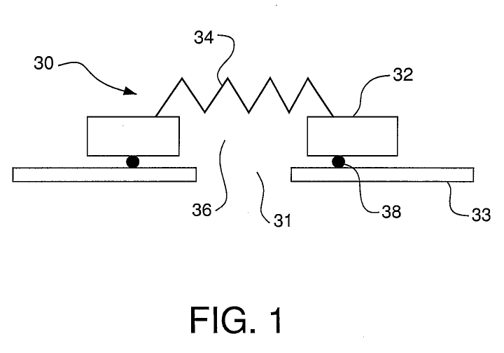

FIG. 1. shows a cross-sectional schematic view of a vent 30 as it may be installed over an aperture 31 in a lighting enclosure 33. The vent comprises of a vent body 32 and a venting element 34. The vent body 32 has an air passageway 36 which, in combination with aperture 31 provides a fluid path between the interior and exterior of the lamp enclosure. The venting element 34 covers the air passageway 36 to form an air permeable, splashproof seal of the passageway. By “splashproof seal” is meant a seal that can withstand a water entry pressure of at least 0.1 psi without leakage.

Sealing fixture 38 facilitates attachment of the vent body 32 to the wall of the lamp enclosure. The means for attachment of the vent body to the lamp enclosure can include interference fittings, snap-fits, o-rings, gaskets, threads or adhesives. Accordingly, the vent body may incorporate barbs, threads and the like to improve attachment.

Preferably, the vent body 32 is constructed from polymeric materials, which facilitate easy processing including heat sealing of the venting element on to the vent body as well as attachment of the vent body to the lamp enclosure. The vent body may be constructed in various shapes and forms including but not limited to rectangular, square or cylindrical. The vent body 32 may take the form of an insert, cap, or a molded part.

The venting element 34 covers the passageway 36 of the vent body. The venting element may be any porous material which has high air permeability and yet offers splash protection against liquid water. Preferably, the porous material has an air permeability of at least 3 Frazier and a water entry pressure of about 0.1 psi. More preferably the porous material has an air permeability of at least 10 Frazier and a water entry pressure of about 0.2 psi. Most preferably the porous material has an air permeability of at least 20 Frazier and a water entry pressure of about 0.5 psi. Porous materials may include but are not limited to, polymeric membranes from Polyethylene, Polypropylene, Polysulfone, Polyethersulfone, Polyvinylidene Fluoride (PVDF), Cellulose Acetate, Polycarbonate, Ultrahigh molecular weight polyethylene (UHMWPE), and preferably expanded PTFE. The expanded PTFE membranes made in accordance with the teachings in U.S. Pat. No. 3,953,566 to Gore are particularly useful.

The venting element 34 may include combinations of the above materials and may also be constructed as a laminate. For example, a porous membrane may advantageously be combined with a support layer to provide structural support. Such supports may be chosen to facilitate attachment of the venting element to the vent body or directly to the lamp enclosure. Suitable support layers can be in the form of air permeable media like knits, non-wovens, scrims, melt-blowns, woven fabrics, meshes, foams, porous expanded PTFE membranes, etc. Support layers may be affixed to the porous membrane by, for example, hot-roll lamination, adhesives, or ultrasonic bonding.

The venting element 34 may be rendered oleophobic, for example U.S. Pat. No. 5,116,650 describes methods of rendering porous media oleophobic. By “oleophobic” is meant an article having an oil rating of at least 2 determined using the AATCC Test method 118-2002. The venting element is affixed to the vent body by any known means including but not limited to adhesive or ultrasonic or heat bonding.

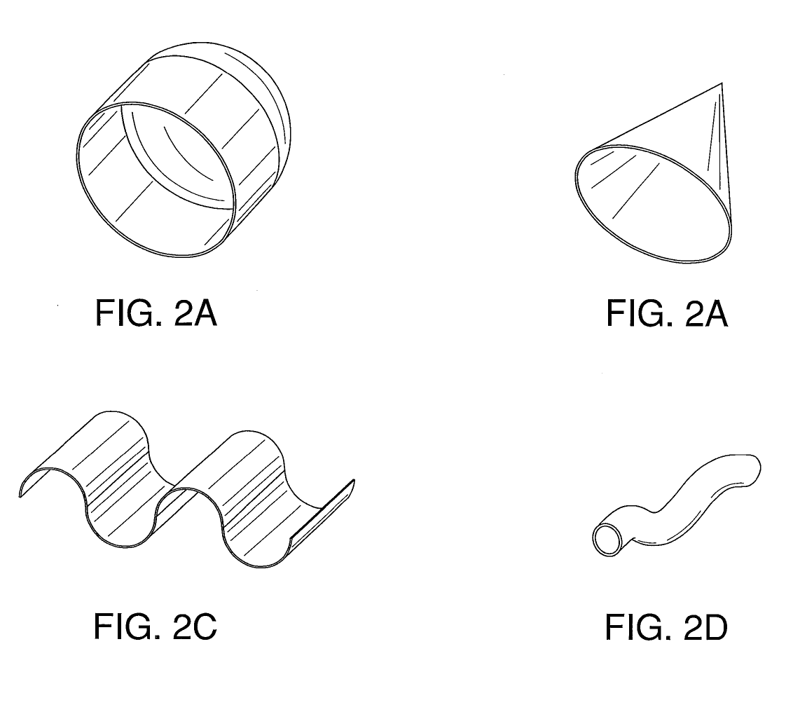

The venting element 34 is non-planar. It may be pleated, folded, curved, ribbed, grooved, ridged, or corrugated. Any shape or configuration may be adopted provided that the surface area of the venting element is greater than the area of the passageway 36 or the aperture 31 on the lamp enclosure. Non limiting examples of non-planar shapes include cones, domes, tubes, pleats and spirally wound forms. Several possible non-limiting examples of non-planar elements are depicted in FIGS. 2a-2d. It should be understood that these and other non-planar shapes can be constructed by methods well known in the art.

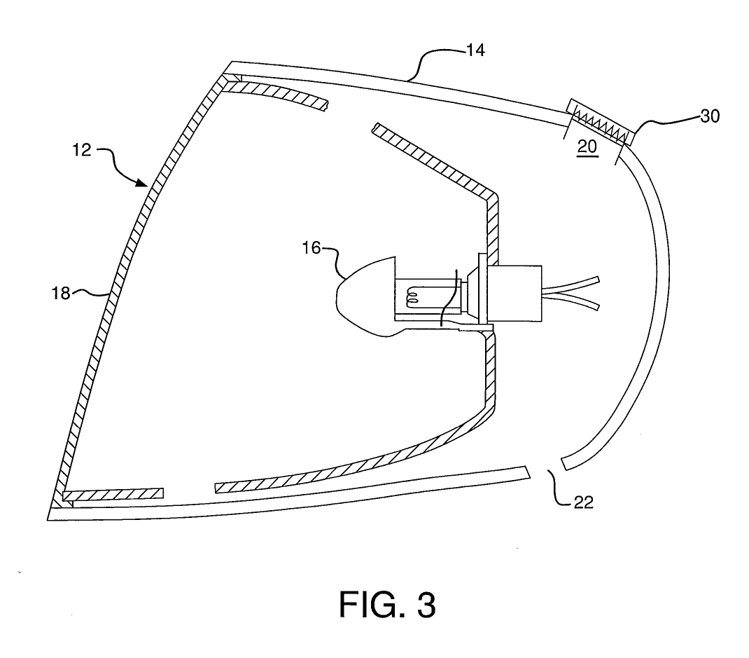

FIG. 3. shows a cross-sectional view of a vehicle lamp enclosure incorporating a ventilation system with two apertures (20, 22). One aperture has a vent 30 installed in it. The lamp enclosure 12 has a wall 14 defining an enclosed volume. The enclosure includes a light source 16 and a lens 18. The light source may be incandescent, tungsten/halogen, LED, HID or any other lamp. The wall 14 has an aperture 20 in the upper half of the lamp enclosure and a second aperture 22 in a second position near the bottom. Such positioning may increase airflow gradient by thermal effects generated by the heat of a lamp 16. Each aperture has an aperture area defined by the cross-sectional area of the aperture.

The apertures may be advantageously located in different external pressure regions. Differing pressure regions may be created by buoyancy effects due to engine compartment temperature gradients and/or from airflow around the lamp. For example, the aperture located in the upper half of the lamp enclosure may experience higher pressure than the aperture located near the bottom of the enclosure due to high airflow near the top of the enclosure which can cause air to be drawn into or out of the lamp enclosure.

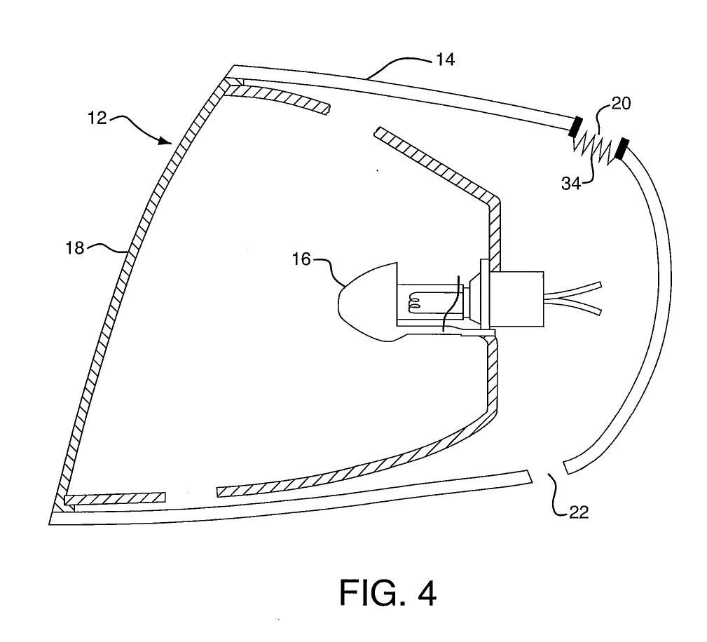

In an embodiment shown in FIG. 4, a lamp enclosure has an aperture 20 and the non-planar venting element 34 is sealed directly over it using heat bonding. In such an embodiment, a vent body is not necessary, rather the aperture 20 is sealed directly by the venting element 34. The surface area of the non-planar venting element is greater than the aperture area.

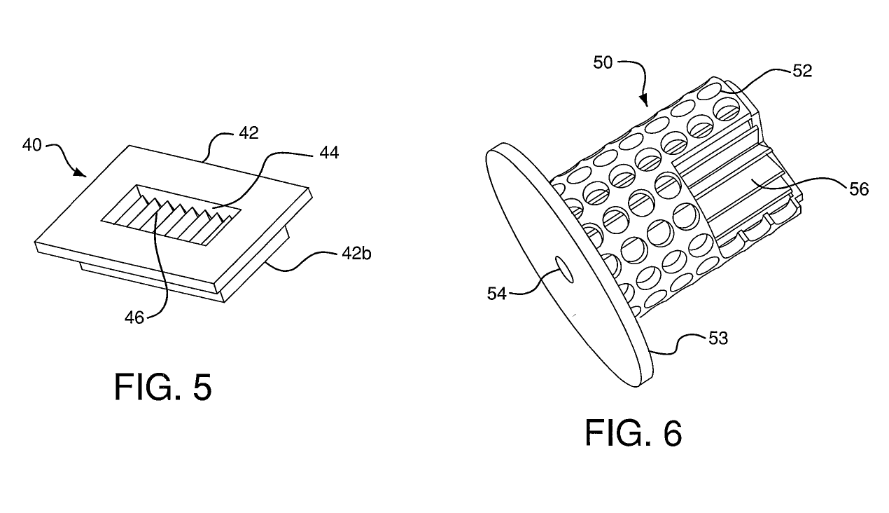

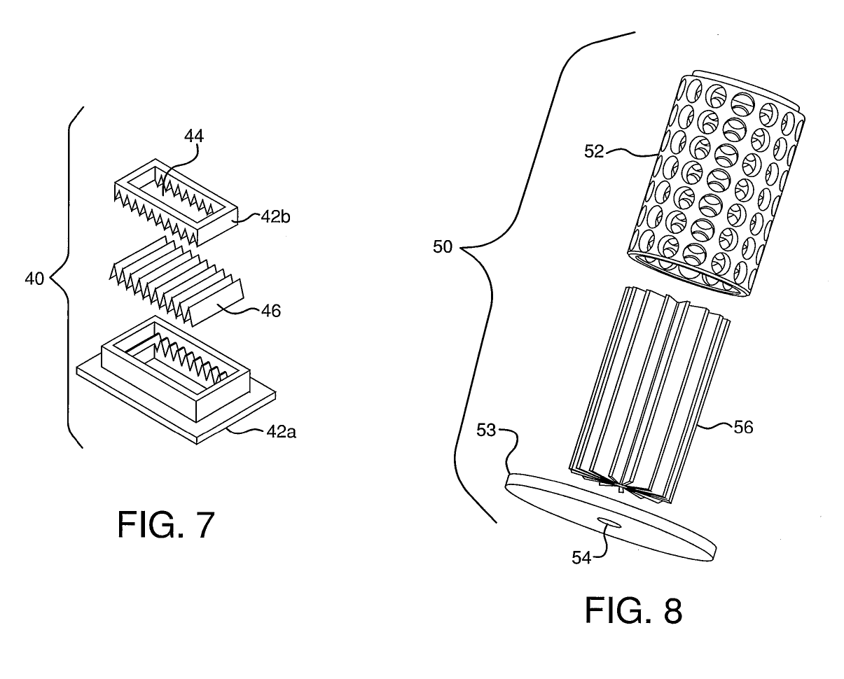

In another embodiment as described in FIG. 5, a vent 40 comprises a rectangular vent body 42 with a passageway 44 covered by a non-planar pleated vent element 46. Preferably, the non-planar vent element 46 comprises a porous expanded PTFE membrane and is constructed in the form of a laminate by supporting the expanded PTFE membrane on a non-woven backer. Pleating of the laminate can be achieved by methods well known in the art. The pleating itself can be of any shape or form or pleat density provided that the resulting surface area of the non-planar venting element is greater than the area of the passageway. FIG. 7 shows the vent in exploded view with like parts having like numbering.

In yet another embodiment described in FIG. 6, the vent 50 comprises a vent body of substantially cylindrical shape. The vent has a base 53 having a passageway 54 covered by a non-planar pleated venting element 56. The venting element may be protected by a cage 52. Although shown having pleats, any non-planar configuration could be chosen provided that the area of the non-planar venting element is greater than the area of the passageway. Preferably, the non-planar venting element 56 comprises a porous expanded PTFE and is constructed in the form of a laminate by supporting the expanded PTFE membrane on a non-woven polymeric backer. The pleating can take any shape or form. FIG. 8 shows the vent in exploded view with like parts having like numbering.

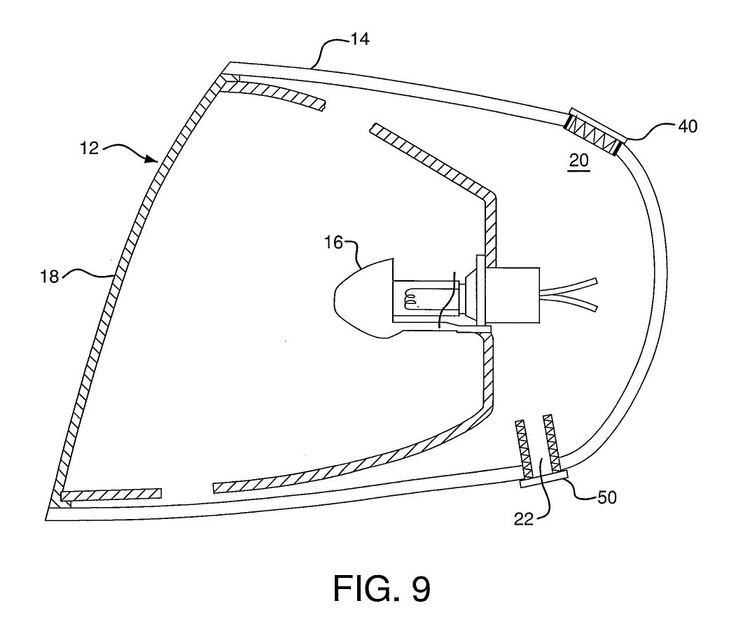

In an alternate embodiment, a vehicle lamp enclosure ventilation system is provided as described in FIG. 9. A vent 40 of substantial rectangular shape and cylindrical vent 50 are positioned over two different apertures 20 and 22 respectively. The vents may be attached to the lamp enclosure wall by using an adhesive or other means. One aperture 20 is located on the upper half of the lamp enclosure while another aperture 22 is located in the bottom of the lamp. When the vehicle is driven, there may be a measurable pressure differential between the two locations causing airflow through the enclosure and air exchange between the enclosed volume and the atmosphere. It should be understood that the vents are interchangeable with regard to their positions. For example, the rectangular vent 40 may be attached to the aperture in the lower part of the enclosure and the cylindrical vent 50 may be attached over the aperture located on the upper half of the enclosure.

### Frazier Test

Air permeability was measured by clamping a flat-sheet of porous sample material into a circular gasketed flanged fixture which provided a circular opening with cross-sectional area of 77.8 cm². The upstream side of the sample fixture was connected to a flow meter in line with a source of dry compressed air. The downstream side of the sample fixture was open to the atmosphere. The Frazier number represents the air permeability of the porous material. It is reported in cubic feet per square foot of sample area per minute at a differential pressure drop across the test sample of 12.7 mm water column.

### Water Entry Pressure Test

Water entry pressure is a test method for measuring water intrusion through a porous material. A flat sheet of sample material was clamped between a pair of testing fixtures. The lower fixture had the ability to pressurize a section of the sample with water. A piece of pH paper was placed on top of the sample to serve as an indicator of evidence for water entry. The sample was then pressurized in small increments of pressure until a color change in the pH paper was noticed. The corresponding breakthrough pressure or entry pressure was recorded as the water entry pressure.

### Vent Air Flow Test

The air flow rate through the vent was measured by sealing the vent in a gasketed test fixture. The upstream side of the test fixture was connected to a flow meter in line with a source of dry compressed air. The downstream side of the test fixture was open to the atmosphere. The air flow rate through the vent (m³/hr) is reported at a differential pressure of 12.7 mm water column.

### Splash Test

The vent was sealed to the orifice of a test fixture plate. The vent was pressurized with water by applying a pressure equivalent to 75 mm water column. This pressure was maintained for 10 seconds. The vent is visually observed for liquid water passage. If no visible water is observed to pass through the venting element itself or through the venting element—vent body interface, then the vent is considered to PASS the splash test. Results from this test are reported in terms of PASS or FAIL values. A vent with a PASS value is considered splash-proof.

### Pressure Differential Test

Differential pressure measurements between the two apertures of the lamp enclosure were made using a pressure transducer (Model FDA602S2K from Ahlborn Mess- und Regelungstechnik GmbH). The transducer was equipped with two ports which were placed near two apertures in a lamp housing. The pressure difference between the two apertures was recorded using a data acquisition system when the vehicle was driven at a speed of 70 mph.

### EXAMPLE 1

An expanded PTFE membrane was affixed to a non-woven polyester backer using hot roll lamination techniques. The properties of the membrane and the resulting laminate are presented in Table I.

TABLE I
Membrane and Laminate Properties

| Property | MEMBRANE | LAMINATE |
|---|---|---|
| Thickness (micron) | 15 | 220 |
| Water Entry Pressure [psi] | 0.2 | 0.8 |
| Air Permeability (Frazier) | 34 | 22 |

2400 mm² of laminate was pleated using a pleating machine with leaf pleating capability. The pleated vent element had a total of 10 pleats, each pleat had a pleat height of 6 mm and pleat width of 20 mm. The final dimension of the non-planar pleated venting element was 34 mm×14 mm.

A vent body was constructed using a stereolithography rapid prototyping system. The material of construction of the vent body was Accura® 25 plastic. The vent body 40 had two components namely a base portion 42a and a mate portion 42b as shown in FIGS. 5 and 7. The vent was assembled by placing the non-planar pleated vent element 46 between the two portions and bonding them together using epoxy. (Armstrong 2 part epoxy; PN 1100052100011 and 2100051300010). The passageway 44 of the vent body was covered by the pleated vent element 46. After allowing for gluing area, 1344 mm2 of pleated vent area was provided to cover the passageway.

The vent was tested for air flow rate and for splash protection against liquid water. The air flow rate through vent produced in this example was 0.47 m3/hr and it passed the liquid water splash test.

### EXAMPLE 2

A sample of the laminate produced in Example 1 was pleated using a pleating machine with leaf pleating capability. The pleat pack itself had a total of 20 pleats, each pleat had a pleat height of 6 mm and pleat width of 25 mm. A venting element of dimension 80 mm×25 mm was cut from the sample.

The vent body was constructed using a stereolithography rapid prototyping system. The material of construction of the vent body was Accura® 25 plastic. The vent body had a base portion 53 and a cage portion 52 as shown in FIGS. 6 and 8. The vent was assembled by placing the non-planar pleated venting element 56 between the two portions and bonding them together using epoxy. (Armstrong 2 part epoxy; PN 1100052100011 and 2100051300010). The passageway 54 of the vent body was covered by the pleated vent element. After allowing for gluing, 4560 mm2 of pleated vent area covered the passageway.

The vent was tested for air flow rate and for splash protection against liquid water. The air flow rate through vent produced in this example was 0.103 m3/hr and it passed the liquid water splash test.

### EXAMPLE 3

An automotive vehicle lamp enclosure ventilation system was constructed using the two vents from Example 1 and Example 2 above. A head lamp enclosure from a 2005 Land Rover LR3 with an HID lamp was used. Two openings were drilled on the lamp enclosure, one at the upper half of the enclosure and the other at a relatively sheltered location at the rear of the enclosure. The dimensions of the opening in the upper half of the enclosure was 26 mm×46 mm and the round opening at the rear of the enclosure was 18 mm in diameter. The vent from Example 1 was attached to the opening in the upper half of the lamp enclosure using an adhesive (Armstrong 2 part epoxy; PN 1100052100011 and 2100051300010). The vent from Example 2 was attached to the opening in the rear of the lamp enclosure using an adhesive (Armstrong 2 part epoxy; PN 1100052100011 and 2100051300010).

While particular embodiments of the present invention have been illustrated and described herein, the present invention should not be limited to such illustrations and descriptions. It should be apparent that changes and modifications may be incorporated and embodied as part of the present invention within the scope of the following claims.

We claim:

1. A lamp enclosure comprising a ventilation system, the ventilation system comprising:
a) first vent located in a first position on said lamp enclosure, said first vent having a first passageway, wherein said first passageway is covered by first air permeable, splashproof venting element, said first air permeable, splashproof venting element having a non-planar shape such that the surface area of said first air permeable, splashproof venting element is greater than the area of first passageway, and
b) second vent located in a second position on said lamp enclosure, said second vent having a second passageway, wherein said second passageway is covered by second air permeable, splashproof venting element, and wherein a pressure difference measurable at the first position and the second position causes airflow within the lamp enclosure.

2. The lamp enclosure of claim 1, in which the first air permeable, splashproof venting element comprises a polymeric membrane.

3. The lamp enclosure of claim 2 in which the polymeric membrane comprises expanded PTFE.

4. The lamp enclosure of claim 1, in which the air permeable splashproof venting element comprises at least one pleat.

5. A lamp enclosure comprising a ventilation system, the ventilation system comprising:
a) first aperture in a first position on said lamp enclosure,
b) vent located over said first aperture, said vent having a passageway, wherein said passageway is covered by an air permeable, splashproof venting element, said air permeable, splashproof venting element having a non-planar shape such that the surface area of said air permeable, splashproof venting element is greater than the area of the passageway, and
c) second aperture located in a second position,
wherein a pressure difference measurable at the first position and the second position causes airflow within the lamp enclosure.

6. The ventilated lamp enclosure of claim 5, in which the non-planar splashproof venting element comprises a porous material having air permeability greater than 5 Frazier.

7. A ventilated lamp enclosure comprising:
a) housing enclosing a lamp;
b) a passageway within said housing between the interior of the lamp enclosure and the exterior of the lamp enclosure, and
c) splashproof, non-planar venting element covering said passageway, said venting element having a surface area greater than the area of said passageway.

8. The ventilated lamp enclosure of claim 7, in which the non-planar splashproof venting element comprises polymeric membrane laminate comprising expanded PTFE and a support material, said laminate having a water entry pressure of at least 0.1 psi, and an air permeability greater than 5 Frazier.

9. A vent for an automotive lamp enclosure comprising:
a) a vent body having a passageway therethrough, and
b) venting element covering said passageway, said venting element comprising a pleated non-planar polymeric membrane laminate comprising expanded PTFE and a support material, said laminate having a water entry pressure of at least 0.1 psi, and an air permeability greater than 5 Frazier.

10. A system for venting a lamp enclosure having two or more apertures therein, the system comprising:
a) a vent body having a passageway therethrough, and
b) venting element covering said passageway, said venting element comprising a pleated non-planar polymeric membrane laminate; the laminate comprising expanded PTFE and a support material, and having a water entry pressure of at least 0.1 psi, and air permeability greater than 5 Frazier.
